(19) United States
(12) Patent Application Publication
(10) Pub. No.: US 2012/0150641 A1
(43) Pub. Date: Jun. 14, 2012

(54) METHOD AND APPARATUS FOR LINKING AND ANALYZING DATA WITH THE DISINTERMEDIATION OF IDENTITY ATTRIBUTES

(76) Inventors: Jeffrey Brooks Dobbs, Alpharetta, GA (US); Matthew Haies, New York, NY (US)

(21) Appl. No.: 12/963,859

(22) Filed: Dec. 9, 2010

(51) Int. Cl. G06Q 30/00

(52) U.S. Cl. 705/14.53

(57) ABSTRACT

An online advertising system includes a computer system that receives conversion data and other event-level data from an ad server computer or a computer of another third party collecting data from or associated with an ad as well as non-personally-identifiable customer data from an advertiser. The computer system uses a customer ID or order ID as a common link to correlate customer data of an advertiser associated with such customer ID or order ID with one or more unique identifiers associated with a particular browser and the online behavior and advertising metrics associated with such unique browser identifiers. The computer system is therefore able be used by advertisers to measure the effectiveness of their online advertising activities and deliver precisely targeted ads to users without tracking the online behavior of their customers, whose online behavior is rendered anonymous.

### TECHNICAL FIELD

The technology disclosed herein relates to online systems and in particular to online advertising systems.

### BACKGROUND

One of the primary features that distinguish online advertising from advertising in other media is the robust data collection capacity of the online medium that enables advertisers to precisely determine which advertisements (hereinafter “ad” or “ads”) and which placements of those ads are most effective for their intended purpose. For example, technologies unique to the online medium allow advertisers to collect data that enables them to measure the return on investment (ROI) of and other consumer response (e.g., clicking on an ad) to various advertising activities. In addition, the medium affords the ability to recognize particular web browsers and therefore enables the production and delivery of targeted ads that are more likely to reach those customers who are interested in an advertiser's products or services.

Although online advertising systems collect, analyze and use data in ways that are very useful and valuable, legislators and regulators have increasingly expressed concerns about certain online advertising activities. For example, data collection, tracking and targeting, particularly where those activities enable a user's identity to be associated with his or her online behavior, are coming under heightened scrutiny. While new laws and regulations are being proposed that would significantly limit the ability of an advertiser to utilize current online data collection, tracking and targeting technologies, existing laws and regulations already restrict certain data practices that would be advantageous to advertisers. Therefore, advertisers are currently faced with two unpalatable choices.

First, they can use the data that is the most beneficial to their business in order to produce targeted advertising and measure ROI and other performance metrics, and run the risk of regulatory inquiries, financial penalties and brand damage. Alternatively, they may voluntarily limit their use of available data that would otherwise be of considerable benefit not only to their online advertising activities but also to their overall commercial operations.

### SUMMARY

The technology disclosed herein relates to a computer system that is operable with an online advertising system to associate event-level online advertising data (hereinafter “event-level data”) with non-personally-identifiable customer data, including one or more of sales, demographic and other customer-related information (in each case, whether collected online or offline) (hereinafter “customer data”). Event-level data may be received from an ad server or from another third party collecting data from or associated with an ad (each, hereinafter, an “event-level data source”). The data are associated in a manner that preserves the anonymity of consumers, while maintaining the ability of advertisers to precisely measure the effectiveness of their advertising activities and deliver ads precisely targeted to their intended audience. In one embodiment, the computer system receives event-level data that includes and associates certain advertising performance metrics (e.g., the websites visited, ads served or the time of day the ads were served, etc.) to an anonymous identifier that is unique to a particular browser. The event-level data also includes and associates that anonymous unique identifier with a unique identifier used by an advertiser to identify a particular customer or a particular purchase, conversion or other action made or performed by that customer. The computer system also receives customer data that includes and is associated with a unique identifier used by an advertiser to identify a particular customer. The computer system can therefore associate advertising performance metrics with particular customer data to determine which advertising activities were most effective to induce consumers to make purchases, register with the advertiser, or undertake such other actions as completing a survey or adding a product to an electronic shopping cart. In addition or alternatively, the computer system can provide anonymized lists of identifiers associated with customers possessing attributes of the advertiser's desired audience to enable the advertiser to effectively target its online advertising activities. The subset of the event-level data that contains the association of the anonymous identifier unique to a particular browser with the unique identifier used by an advertiser to identify a particular customer or a particular purchase, conversion or other action made or performed by that customer is hereinafter called “conversion data.” As with all of the event-level data, conversion data cannot be used by the computer system to identify consumers.

In one embodiment, the anonymous identifier that is unique to a particular browser is a cookie ID. In another embodiment, the anonymous identifier that is unique to a particular browser is an IP address or other unique digital fingerprint created from the information provided by the browser (or any future attribute or combination of attributes passed by a web browser and linked to a browsing session) of a computer used by the user.

In one embodiment, the computer system matches event-level data recorded by an ad server with customer data associated with a customer ID. In another embodiment, the computer system matches event-level data recorded by a third party, other than an ad server, collecting data from or associated with the ad with customer data associated with a customer ID. In another embodiment, the computer system matches event-level data recorded by the ad server with customer data associated with an order ID. In another embodiment, the computer system matches event-level data recorded by a third party, other than the ad server, collecting data from or associated with the ad with customer data associated with an order ID.

In one embodiment, the computer system produces reports for an advertiser or other authorized user that associates online advertising performance metrics with customer data. In another embodiment, the computer system produces lists of cookie IDs or other identifiers that are unique to particular browsers and are associated with demographic attributes desired by the advertiser, which demographic attributes are a subset of the customer data. In the preceding embodiment, the lists produced by the computer system may be (1) lists of cookie IDs or other unique identifiers derived only from the requesting advertiser's event-level data or (2) lists of cookie IDs or other unique identifiers derived from the event-level data of all advertisers participating in a data cooperative program made available in the computer system, whereby participating advertisers make their anonymized event-level data shareable in the aggregate with the anonymized event-level data of other participating advertisers and are able to avail themselves of the aggregated set of shared anonymized event-level data.

### BRIEF DESCRIPTION OF THE DRAWINGS

FIG. 1 illustrates a conventional online advertising system.

FIG. 2 illustrates one method by which personally-identifiable information known to an advertiser can become associated with online behavior data stored by an ad server.

FIG. 3 illustrates how a user's online behavior can become associated with personally-identifiable information.

FIG. 4 illustrates a system for ensuring the anonymity of user online behavior in accordance with an embodiment of the disclosed technology.

FIG. 5 illustrates a block diagram of an online advertising system in accordance with an embodiment of the disclosed technology.

### DETAILED DESCRIPTION

As discussed above, the technology disclosed herein relates to online advertising systems and in particular to a method and apparatus for processing and analyzing data to measure the performance of advertising activities and enable the delivery of ads targeted to segments of consumers while ensuring the anonymity of user online behavior information.

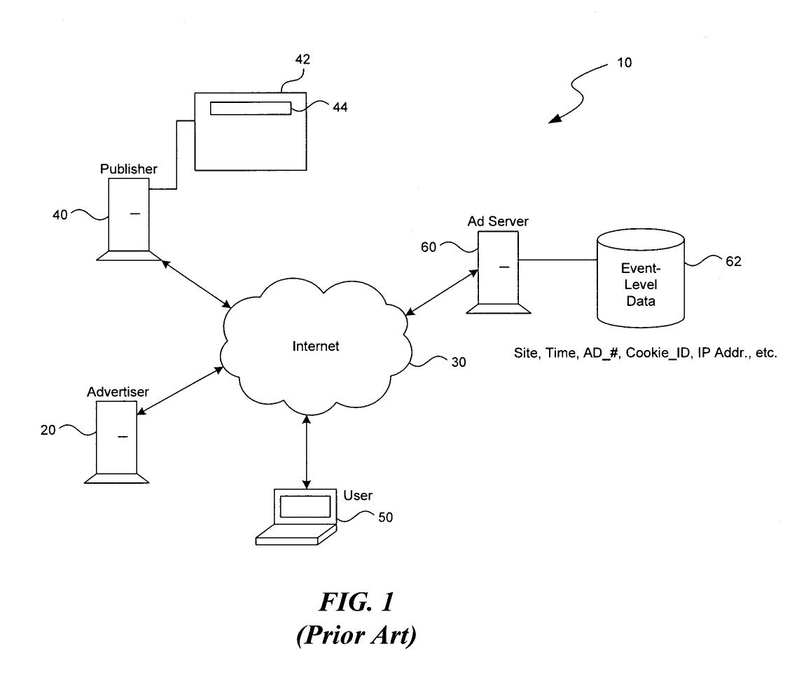

FIG. 1 illustrates a conventional online advertising system by which users who access various websites on the Internet are presented with one or more advertisements. In the online advertising system 10 illustrated, an advertiser 20 desires to advertise its products or services to one or more potential customers. Typically, the advertiser 20 has an online presence (i.e., a website) that customers can access through a computer communication link such as the Internet 30. As will be appreciated by those skilled in the art of online advertising, the advertiser 20 typically contracts with an advertising agency to develop a campaign of advertisements that includes both the content of the ads and a plan for where and when those ads should be placed. In many instances, the ads are placed with a number of online publishers 40 having popular websites that are likely seen by a large number of potential customers of the advertiser 20. For example, advertisements may be placed on a home page of a popular website such as “www.cnn.com” or “www.nytimes.com.” Alternatively, advertisements may be placed at more specific sites such as the Home & Garden page of www.nytimes.com, etc.

A user accesses the Internet 30 with a computing device 50 that includes a web browsing program such as Microsoft Internet Explorer, Mozilla Firefox, Google Chrome, Apple Safari and the like. The computing device 50 can be a desktop or laptop computer, mobile computing device such as an Internet capable cellular phone (i.e., smart phone), personal digital assistant (PDA), slate computer, electronic book reader, handheld or console gaming device or the like.

When the user directs his or her browser program to the website of the publisher 40, the web server downloads a number of markup instructions that inform the user's browser how to render a web page 42. Often the instructions will contain an ad tag that will cause an ad 44 to appear at a designated position such as in the banner of the web page 42. The ad tag instructs the user's browser to go to an ad server 60 in order to retrieve markup code and graphics to render a particular advertisement for inclusion into the web page 42.

After receiving the markup instructions from the publisher's website 40, the browser program running on the user's computer 50 calls the designated ad server 60. The browser program passes information such as the computer's internet protocol (IP) address, the type of browser program being used and other information. If the browser does not include a unique identifier cookie in the information it passes to the ad server 60, the ad server will respond with a request for the browser to store a unique cookie. The cookie may be returned by the browser when it subsequently passes information to the ad server. The ad server 60 then chooses the appropriate advertisement and records an event in an event-level data log that is stored in a database 62 associated with the ad server 60. Each event in the event-level data log may include such information as a record of the publisher's web site from which the user's browser program was referred, the time and date on which the user accessed the publisher's web site, the ID of the ad that is chosen to be sent to the browser, the ID of the cookie associated with the browser, the IP address of the user's computer 50 and other information. After the event-level data is recorded, the assets for the selected ad are digitally delivered to the browser program so that the browser can render the web page 42 with the advertisement 44 shown in its correct position.

If the user accesses another website that refers the user's browser to the ad server 60, the ad server 60 recognizes the cookie previously provided to the browser program and places another event entry into the event-level data log.

As will be appreciated by those skilled in the art, the event-level data log stored in the database 62 by the ad server 60 contains a record of each website visited by the user that requests that an advertisement from the ad server 60 be delivered to the user's browser. That event-level data stored by the ad server 60 is anonymous. Nothing in the event-level data can be attributed to the name or address of any particular individual. However, the event-level data may become non-anonymous and associated with a particular individual in a number of ways, including when a user registers with or purchases an item from the advertiser 20, which results in the inclusion of conversion data within the event-level data.

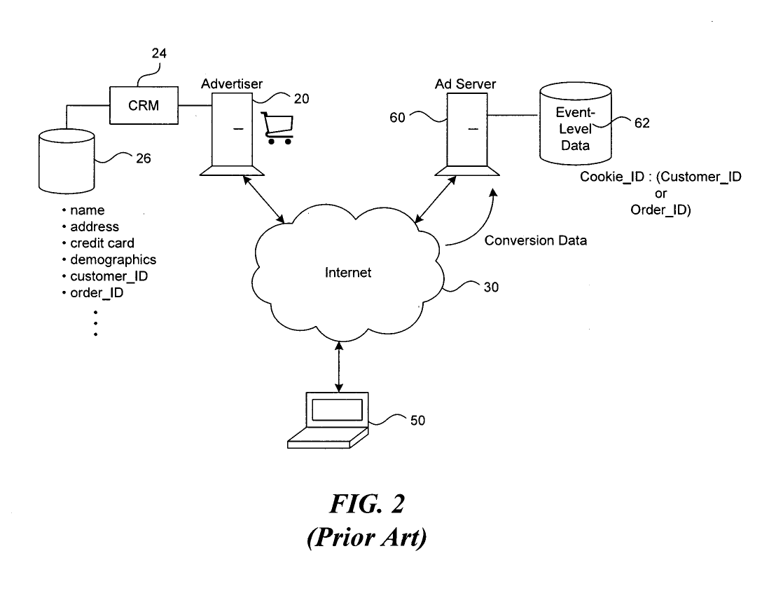

FIG. 2 illustrates one mechanism by which event-level data stored by an ad server 60 can become associated with the personally-identifiable information of a user. When a customer registers with, purchases an item from or undertakes certain other actions selected by an advertiser 20, such as completing a survey or adding a product to an electronic shopping cart, personally-identifiable information is collected from the customer that can include his or her name, address, credit card number, and possibly some demographic information. The advertiser's customer records management (CRM) system 24 typically assigns the newly-registered customer a customer ID and stores the personally-identifiable information and customer ID in a records database 26. In addition, if the customer purchases an item, the CRM system 24 typically assigns an order ID to the particular purchase. In many cases, a checkout web page or customer registration web page will dynamically create an ad server pixel tag containing a reference to the order ID and/or the customer ID. The dynamic pixel tag is downloaded to the customer's browser program, which causes the browser to call the ad server 60 and pass information such as the IP address of the user's computer 50, the cookie ID associated with the browser, and the order ID and/or customer ID to the ad server 60. The ad server 60 records the pairing of the cookie ID to the received customer ID and/or order ID as conversion data. The ad server 60 may then return a 1×1 pixel image to the customer's browser program. The 1×1 pixel cannot be seen in the web page generated by the customer's browser program. Such 1×1 pixels are often referred to as web bugs or web beacons. In this case, the request to the ad server 60 was not meant to present content to the customer but instead to cause the customer's browser program to provide the conversion data to the ad server 60.

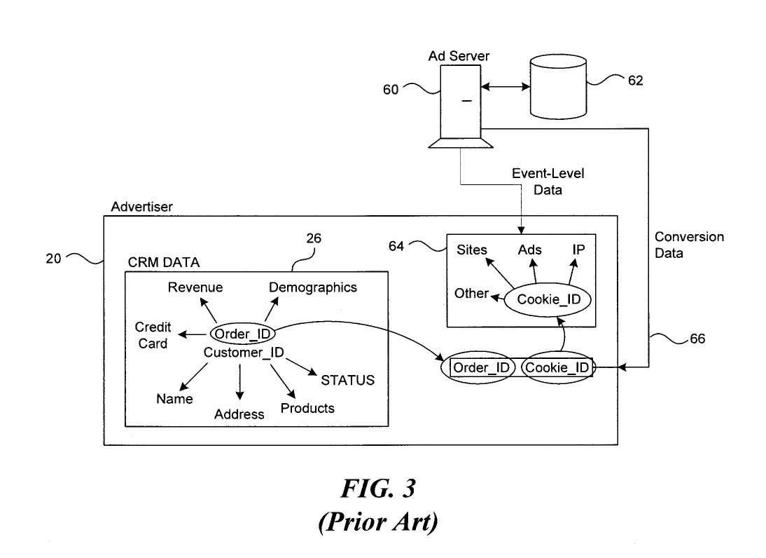

In most cases, the advertiser 20 is provided with or can obtain the event-level data stored by the ad server 60 that is associated with the ads that were served for the advertiser. As shown in FIG. 3, if the ad server 60 provides the event-level data 64 (which also includes the conversion data 66, which is drawn separately from the event-level data solely for illustrative purposes) to the advertiser, the advertiser would have sufficient information to track the online behavior of an actual identifiable customer. For example, the CRM data linking a customer's name, address, revenue, demographics, etc. can be indexed by the customer's order ID and/or customer ID, and the online behavior of a customer, including the browsing history of the web sites viewed by a customer for which an ad was delivered, the particular ads that were delivered to a customer and/or the search queries of a customer, can be indexed by the customer's cookie ID. The conversion data 66 links a particular customer ID and/or order ID to a particular cookie ID. Therefore, with the information contained in the event-level data log 64, which also contains the conversion data 66, the advertiser 20 can determine the online behavior such as the browsing history and/or search queries of each registered customer who has been served its ads. Online behavior, almost universally understood to be anonymous, would in fact be identifiable back to an individual's offline identity.

With a record of which websites and ads were viewed by a customer and what purchases, conversions or other actions were made or performed by a customer, the advertiser can determine which ads are performing the best and where the placement of those ads generates the best results. However, legislators, regulators and consumers understand online behavior to be private and anonymous. In addition, the ability of the advertiser to determine which websites were presented to a customer from the event-level data log 64 may place the publishers of those websites in violation of their own privacy policies if, for example, the publisher, unaware of the advertiser's activities, falsely represents to users that their activities are anonymous to advertisers. As a result, many advertisers are voluntarily not using their event-level data to the fullest extent possible, if at all. Therefore, advertisers are limited in their ability to determine which of their advertising activities generate the most revenue and to utilize their own data to target ads to their most likely customers.

To maintain the anonymity of a customer's online behavior while allowing advertisers the ability to better measure the effectiveness of their ads and deliver more relevant ads to users, the technology disclosed herein utilizes a computer system 100 that operates as a wall between the ad server 60 and the advertiser 20. The computer system 100 may be implemented as a stand-alone or networked Internet-based computer system that includes one or more processors that execute a sequence of programmed instructions. The instructions may be stored on a non-transitory, computer readable media.

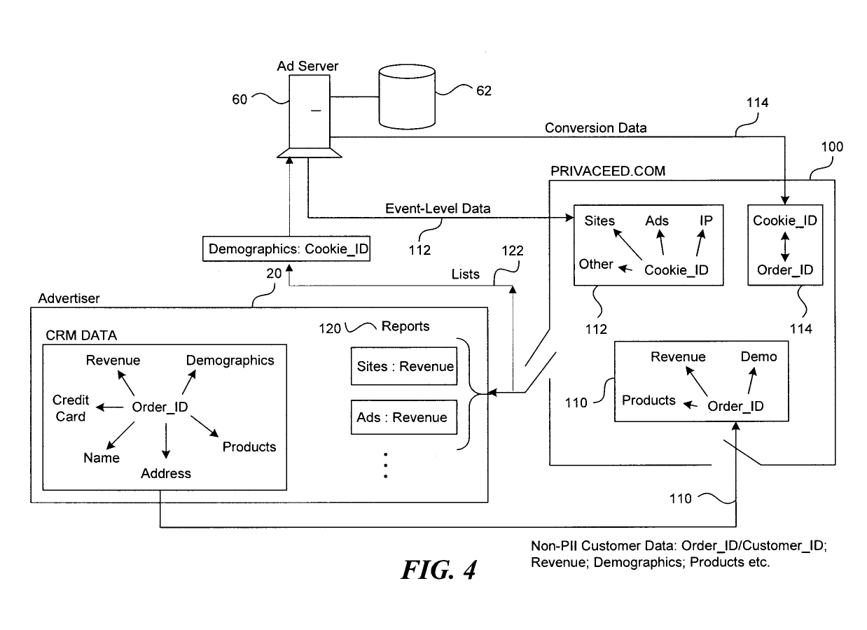

As shown in FIG. 4, the computer system 100 is configured to receive customer data 110 (which is not personally-identifiable) from an advertiser's CRM database. The customer data 110 can include, for example, one or more of the dollar amount of a sale or intended purchase, the dollar amount associated with the item or items placed in a shopping cart, the status of an order, the SKU of a product purchased, general demographic information of the customer, such as gender, occupation, age, marital status, household income, etc. The customer data 110 includes an order ID and/or a customer ID or other unique identifier that the advertiser 20 can use to identify a particular individual, but cannot be used by the computer system 100 to identify a particular individual.

In some embodiments, the computer system 100 can operate to review the customer data received from the advertiser to ensure that it does not contain any personally-identifiable information. For example, the computer system 100 can scan the received customer data to determine if any personally-identifiable information, such as a name or e-mail address is included. If so, the computer system 100 can filter such entries in the customer data.

The computer system 100 also receives the event-level data 112, including the conversion data 114 (which is drawn separately from the event-level data solely for illustrative purposes), from the ad server 60. The computer system 100 can normalize and filter the event-level data 112 upon receipt. For example, the data may be out of order or may contain errors that need to be corrected. In another example, a cookie ID in the event-level data 112 may be required to have a certain number of letter and numbers. Codes in the logs of the event-level data 112 that do not have the correct number of letters or numbers may be normalized and/or filtered. In addition, event-level data 112 that is older than a defined date may be removed as being stale, which would also address concerns about data being stored for unnecessarily long durations. The customer data 110 received from the advertiser 20 and the event-level data 112, including the conversion data 114, received from the ad server 60 can be stored in a database maintained by the computer system 100.

With the event-level data 112, including the conversion data 114, received from the ad server, the computer system 100 can correlate the unique identifier used by the ad server to refer to a particular browser to the unique identifier used by the advertiser to refer to a particular customer. With the customer data 110 received from the advertiser 20, the computer system 100 can correlate purchase and/or other conversion information, such as revenue and product information, to the unique identifier used by the advertiser to refer to a particular customer. With both the event-level data 112 and the customer data 110, the computer system 100 can correlate the unique identifier used by the ad server to refer to a particular browser, as well as such online behavior as the ads viewed, sites visited and search queries made by that browser, to the customer data 110, without utilizing any information that would enable the identification of a user. In one embodiment, the computer system 100 uses a customer ID or order ID as a common link to relate customer data 110, such as revenue, to a cookie ID in the event-level data 112. In another embodiment, the computer system 100 uses a customer ID or order ID as a common identifier to relate customer data 110, such as revenue, to an IP address in the event-level data 112. In another embodiment, the computer system 100 uses a customer ID or order ID as a common identifier to relate customer data 110, such as revenue, to another unique digital fingerprint created from the information provided by the browser in the event-level data 112. The computer system 100 can generate reports 120 that show, for example, a relationship between the websites that were visited by a customer, which information is in the event-level data 112, and customer data 110 such as revenue generated, products sold to a customer, etc., in a manner that eliminates the ability of the advertiser to identify that customer from such reports. Alternatively, the computer system 100 can generate reports that show the relationship between the particular ads or the placements of those ads presented to a customer to the revenue generated, also in a manner that eliminates the ability of the advertiser to identify that customer from such reports. Furthermore, the computer system 100 can generate from the data lists 122 of cookie IDs or other unique identifiers (e.g., IP addresses or other digital fingerprints) of a computer used by the user associated with particular desired demographics as selected by the advertiser. For example, the advertiser may wish the computer system 100 to recognize and compile a list of cookie IDs associated with male customers age 35 to 44 that have an interest in golf or other sports. The list 122 of matching cookie IDs or other unique identifiers generated will contain a sufficient number (e.g., 50 or greater) that make it unfeasible to identify any individual; otherwise, the list 122 generated by the computer system 100 will not be made available to the advertiser. The list generated by the computer system may be (1) a list of cookie IDs or other unique identifiers derived only from the requesting advertiser's event-level data or (2) a list of cookie IDs or other unique identifiers derived from the event-level data of all advertisers participating in a data cooperative program made available in the computer system.

The reports produced by the computer system 100 can be made available on an FTP or other secure server or can be sent to the advertiser or other authorized requester via e-mail or via some other mechanism. The lists generated by the computer system 100 can be made available on an FTP or other secure server or can be sent to the applicable ad server or other authorized requester via e-mail or via some other mechanism. In one embodiment, the computer system 100 is connected to the advertiser 20 and the ad server 60 via a computer communication link such as the Internet 30. The computer system 100 may be accessible on the Internet via a website such as “clients.privaceed.com.” In some embodiments, the advertiser 20 or other authorized customer of the computer system 100 is charged per report or list generated. Alternatively, the advertiser or other authorized customer of the computer system 100 can be changed a daily, weekly, monthly, yearly or one-time fee to use the report and/or list generation services of the computer system 100. In yet another embodiment, the advertiser or other authorized customer of the computer system 100 can be charged depending on the number of lines or volume of event codes that are analyzed by the computer system 100.

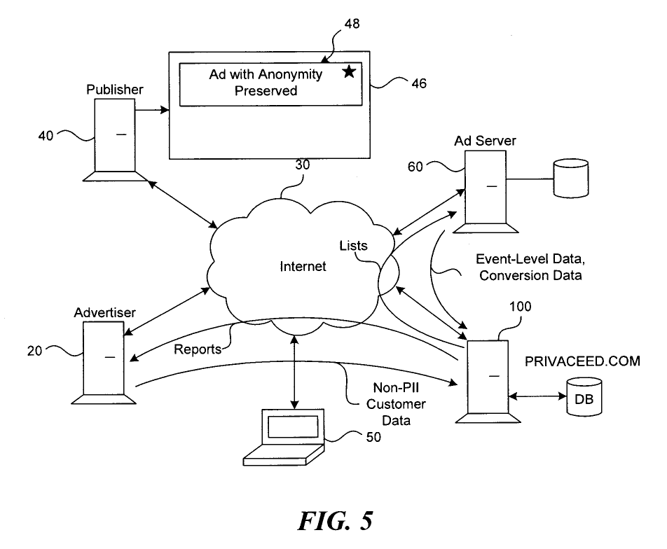

FIG. 5 illustrates one embodiment of an advertising system that includes an advertiser 20, a publisher 40, and an ad server 60 that are all connected via a computer communications link 30 such as the Internet. A user accesses the advertiser 20 or publisher 40 with a browser program running on his or her computing device 50. In addition, the advertising system includes the computer system 100 that operates in accordance with the disclosed technology. In one embodiment, the computer system 100 receives event-level data, including conversion data, from the ad server 60 as well as customer data 110 from the advertiser 20. The computer system 100 can produce reports for the advertiser or other authorized user that analyze the relationship between ads and the online behavior so that the advertiser can determine the effectiveness of the advertiser's advertising activities. In addition, the computer system 100 can compile lists of cookie IDs that match desired demographic attributes selected by the advertiser. The lists compiled by the computer system may be (1) lists of cookie IDs or other unique identifiers derived only from the requesting advertiser's event-level data or (2) lists of cookie IDs or other unique identifiers derived from the event-level data of all advertisers participating in a data cooperative program made available in the computer system. The lists can be supplied to the ad server 60 such that when a browser program associated with a cookie ID on a list requests an ad from the ad server 60, the ad server 60 can recognize the cookie ID and can serve an ad that is pertinent to the selected demographic.

In the embodiment described above, the ad server 60 uses a customer ID or order ID as a common link to associate customer data 110, such as a demographic attribute, with a cookie ID provided by the ad server. However, in lieu of a cookie ID, another identifier that is unique to a particular user's computer 50 and available from the event-level data, such as IP address or other unique digital fingerprint created from the information provided by the browser, could also be associated with the customer data 110. The use of these alternative identifiers can allow the disclosed technology to operate both across multiple ad servers and with respect to browsers that do not have active cookies.

In yet another embodiment, advertisers that elect to utilize the services of the computer system 100 may elect to provide an indication on their advertisements that indicates to customers who purchase their products and services or otherwise provide data about themselves that such data will not be identifiable by the advertiser on other websites 46. Such advertisements may be indicated by a particular icon 48, color or other symbol, which serves to indicate that users' online behavior, such as their browsing activities and search queries, cannot be identified, analyzed or tracked by the advertiser.

The embodiments described above relate to online advertising systems but can be embodied in any system that receives from multiple sources data containing a common unique identifier that is associated with different meanings in those sources, and in particular any such system in which one of those sources associates the common unique identifier with personally-identifiable information of a particular individual.

The embodiments illustrated by the Figures relate to the receipt of event-level data from an ad server, but can be embodied with respect to the receipt of event-level data from any third party collecting data from or associated with an ad.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide. area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A computer system, comprising:
processor electronics configured to perform operations including:
receiving event-level data from an event-level data source computer that relates information regarding the advertising served to a browser to a unique identification code associated with the browser;
receiving conversion data that relates a unique identification code associated with a customer to the unique identification code associated with the browser;
receiving customer data that relates non-personally-identifiable customer information to the unique identification code associated with a customer; and
relating the advertising information served to a browser with the non-personally-identifiable customer-related information using the conversion data in a manner that does not disclose to the advertiser an identity of the customer associated with the browser.

2. The computer system of claim 1, wherein the unique identification code associated with the browser is a cookie ID.

3. The computer system of claim 1, wherein the unique identification code associated with the browser is an IP address.

4. The computer system of claim 1, wherein the unique identification code associated with the browser is a fingerprint created from information provided by a browser program of a computer.

5. The computer system of claim 1, wherein the unique identification code associated with the customer is a customer ID.

6. The computer system of claim 1, wherein the unique identification code associated with the customer is an order ID.

7. The computer system of claim 1, wherein the event-level data source is an ad server.

8. The computer system of claim 1, wherein the event-level data source is a third party, other than an ad server, collecting data from or associated with an ad.

9. A computer system comprising:
a memory for storing (1) event-level data received from an event-level data source computer that contains online behavior information of users that receive ads from an advertiser, wherein the users' browsers are recognized by unique identifiers that are not known to the advertiser, but which are included in the event-level data, (2) customer data containing non-personally-identifiable customer information, wherein the customers are recognized in the customer data by unique identifiers but are not recognizable by the ad server or the computer system, and (3) received conversion data, which is a subset of event-level data, received from an event-level data source computer, that associates the unique identifier used by the event-level data source and included in and associated with the users' browsers in the event-level data with the unique identifier known to the advertiser and included in and associated with sales, demographic and other customer-related information in the customer data; and
a processor configured to perform operations including:
determining relationships between the customer data and the online behavior information included in the event-level data in a manner that ensures the anonymity of the customers who engaged in the online behavior.

10. The computer system of claim 9, wherein the online behavior information is a component or components of browsing history, such as the sites visited or ads viewed.

11. The computer system of claim 9, wherein the online behavior information is a search query or queries of a user.

12. The computer system of claim 9, wherein the unique identifier used by the event-level data source is a cookie ID.

13. The computer system of claim 9, wherein the unique identifier used by the event-level data source is the IP address of a computer.

14. The computer system of claim 9, wherein the unique identifier used by the event-level data source is a fingerprint created from information provided by a browser program of a computer.

15. The computer system of claim 9, wherein the unique identifier known to the advertiser is a customer ID.

16. The computer system of claim 9, wherein the unique identifier known to the advertiser is an order ID.

17. The computer system of claim 9, wherein the event-level data source is an ad server.

18. The computer system of claim 9, wherein the event-level data source is a third party, other than an ad server, collecting data from or associated with an ad.

19. A computer-implemented method for analyzing advertising data, comprising:
receiving with a computer, event-level data from an event-level data source computer that relates advertising information served to a browser to a unique identification code associated with the browser;
receiving with the computer, conversion data from an event-level data source computer that relates a unique identification code associated with a customer to the unique identification code associated with the browser;
receiving with the computer, customer data that relates non-personally-identifiable customer information to the unique identification code associated with a customer; and
relating with the computer, the advertising information served to a browser with the customer data in a manner that preserves the anonymity of the customer associated with the browser.

20. The computer-implemented method of claim 19, wherein the unique identification code associated with the browser is a cookie ID.

21. The computer-implemented method of claim 19, wherein the unique identification code associated with the browser is the IP address of a computer.

22. The computer-implemented method of claim 19, wherein the unique identification code associated with the browser is a fingerprint created from information provided by a browser program of a computer.

23. The computer-implemented method of claim 19, wherein the unique identification code associated with a customer is a customer ID.

24. The computer-implemented method of claim 19, wherein the unique identification code associated with a customer is an order ID.

25. The computer system of claim 19, wherein the event-level data source is an ad server.

26. The computer system of claim 19, wherein the event-level data source is a third party, other than an ad server, collecting data from or associated with an ad.

27. A non-transitory, computer-readable media with instructions stored thereon that are executable by a computer to perform operations, comprising:
receiving event-level data from an event-level data source computer that relates advertising information served to a browser to a unique identification code associated with the browser;
receiving conversion data from an event-level data source computer that relates a unique identification code associated with a customer to the unique identification code associated with the browser;
receiving customer data that relates non-personally-identifiable customer information to the unique identification code associated with a customer; and
relating the advertising information served to a browser, which information is included in the event-level data, with the customer data in a manner that preserves the anonymity of the customer associated with the browser.

28. The non-transitory, computer-readable media of claim 27, wherein the unique identification code associated with the browser is a cookie ID.

29. The non-transitory, computer-readable media of claim 27, wherein the unique identification code associated with the browser is the IP address of a computer.

30. The non-transitory, computer-readable media of claim 27, wherein the unique identification code associated with the browser is a fingerprint created from information provided by a browser program of a computer.

31. The non-transitory, computer-readable media of claim 27, wherein the unique identification code associated with a customer is a customer ID.

32. The non-transitory, computer-readable media of claim 27, wherein the unique identification code associated with a customer is an order ID.

33. The non-transitory, computer-readable media of claim 27, wherein the event-level data source is an ad server.

34. The non-transitory, computer-readable media of claim 27, wherein the event-level data source is a third party, other than an ad server, collecting data from or associated with an ad.
